(19) United States
(12) Patent Application Publication
(10) Pub. No.: US 2005/0140134 A1
(43) Pub. Date: Jun. 30, 2005

(54) Page-keepers

(76) Inventor: FrancineKay Marcus, Wake Forest, NC (US)

Correspondence Address: FrancineKay Marcus, 5316 Chimney Swift Drive, Wake Forest, NC, 27587, US

(21) Appl. No.: 10/747,645

(22) Filed: Dec. 29, 2003

(51) Int. Cl. B42D 9/00

(52) U.S. Cl. 281/42

(57) ABSTRACT

This is a new type of bookmark which is designed to fit all different size books. It will keep your place. It will not fall out. It will help you know where you are if the book closes because it remains in place until you move it. The items used are all different types of small items. Mostly glass or plastic beads are used. Using different colors or same colors. The items used can take up no more than half the length of the elastic due to the fact that the elastic that goes inside the book must be free of any item so it will not damage the book in any way. The beads or charms are used to appeal to women, men and children. Some are pretty with pretty colors some are bold using beads that may appeal more to a male and some are made with brightly colored beads or items that appeal to a young reader. Seashells, miniature sports and religious items are also used to appeal to individual interests.

### CROSS-REFERENCE TO RELATED APPLICATIONS

Not Applicable

### STATEMENT REGARDING FEDERALLY SPONSORED REASEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

A new type of bookmark. One in which you can not lose your place in a book. Other types of bookmarks fall out and this will not fall out. So if your book drops or closes you will still have your place marked.

### BRIEF SUMMARY OF THE INVENTION

This is an item made of a thin piece of elastic, then strung with beads or other items that will go along the outside of the binding of a book. Inside the elastic is smooth and takes no room. This was made to slip on your book to keep your place even if the book falls or closes by accident. It moves easily from page to page and there are many colors and styles to choose from. All items are made to stay on the outside of the binding of a book. The band is made of black, white, gold or silver elastic. Beads, charms, seashells, buttons etc. are all used to make this attractive to men, women and children. These items go along the outside of the book, only. Inside the book is just the elastic which is easy to move and does not harm the book in any way.

### BRIEF DESCRIPTION OF THE DRAWINGS

FIG. 1, is a book with a Page-Keeper on it.

FIG. 2, is a picture of just a Page Keeper.

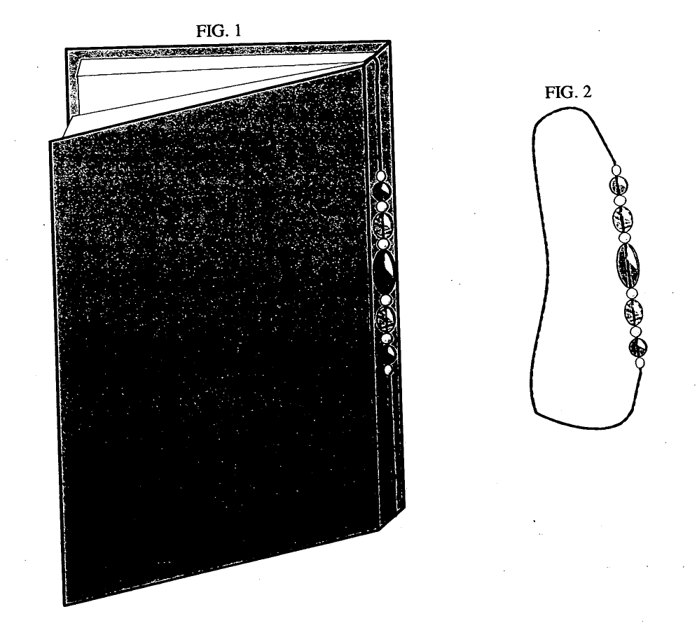

### DETAILED DESCRIPTION OF THE INVENTION

Use a 0.5 mm black, white, silver or gold piece of elastic cord or thread. Length approximately 8 inches long. Glass or plastic beads, small charms, seashells, buttons or any other small item is threaded onto the elastic. Items are centered on the elastic. Knots are made at either end of the items. The knots keep the items centered on the elastic. Then the two ends of the elastic are knotted together. This will then slip easily onto your book. The beads or other items are on the outside of the book along the binding. Because the elastic is so thin, which is inside the book, the pages are not harmed in any way. The Page-Keeper can remain on the book as you read and moved easily from page to page or section to section.

1: (canceled)

2: A page-keeper for encircling a book to hold a place within the book. Consisting of an elastic band where decorative beads are secured on the elastic band, such that when the Page-Keeper is placed on the book to hold the place, all the beads are on the outside along the binding of the book and the plain elastic is inside holding the place within the book.

3: The Page-Keeper of claim 2, the beads are strung and centered on the elastic band. Elastic band is knotted on either side of the beads to limit the movement of the beads, keeping them somewhat centered. Open ends of elastic are then knotted together, to close.

4: The Page-Keeper of claim 2, beads are decorative and colorful and makes your book stand out while keeping your place.

5: The Page-Keeper of claim 2, will remain in place until you move the elastic in between any other two pages.
